(19) United States
(12) Patent Application Publication
(10) Pub. No.: US 2010/0018474 A1
(43) Pub. Date: Jan. 28, 2010

(54) METHODS AND ADAPTER SYSTEMS FOR MANAGING SLACK IN LEASHES

(76) Inventor: Mark Noonan, New Canaan, CT (US)

Correspondence Address: HARNESS, DICKEY, & PIERCE, P.L.C, 7700 Bonhomme, Suite 400, ST. LOUIS, MO, 63105, US

(21) Appl. No.: 12/179,759

(22) Filed: Jul. 25, 2008

(51) Int. Cl. A01K 27/00; A43C 5/00

(52) U.S. Cl. 119/792; 119/797; 24/713.6

(57) ABSTRACT

According to various aspects, exemplary embodiments are provided of a system for managing slack in a leash, such as when the leash is attached to a collar worn by an animal. In one exemplary embodiment, the system generally includes an elastic adapter and at least one eyelet operatively associated with the elastic adapter member. The eyelet includes an opening therethrough configured to frictionally receive at least a portion of the leash therein. A first member is adjacent a proximal end portion of the elastic adapter for anchoring, attaching, or engaging to the leash. A second member is adjacent a distal end portion of the elastic adapter for anchoring, attaching, or engaging to the leash.

### FIELD

The present disclosure relates generally to an adapter system to manage slack in a leash, such as while walking a dog.

### BACKGROUND

The statements in this background section merely provide background information related to the present disclosure which is not necessarily prior art.

It is common practice for owners of dogs and other pets to regularly walk or exercise their pets. Proper control of the pet and laws of many municipalities require that pets be restrained by a leash. Typically, the leash is a piece of material with a handle to be held by the owner or pet walker and a clip for attachment to the pet's collar.

### SUMMARY

This section provides a general summary of the disclosure, and is not a comprehensive disclosure of its full scope or all of its features.

According to various aspects, exemplary embodiments are provided of an adapter system to manage slack in a leash. In one exemplary embodiment, a device attachable to a leash for managing slack in the leash generally includes an elastomeric member and at least one eyelet integral to the elastomeric member. The at least one eyelet includes at least one opening configured to frictionally receive at least a portion of the leash therein. The device may also include a first member integral to the elastomeric member for anchoring, attaching, or engaging to the leash, for example, without requiring or using mechanical fasteners. The device may also include a second member for anchoring, attaching, or engaging to the leash, for example, without requiring or using mechanical fasteners. The elastomeric member, the at least one eyelet, and the first and second member may be comprised of thermoplastic rubber or thermoplastic resin material, and the device may be monolithically formed to have a single-piece construction.

In another exemplary embodiment, a system for managing slack in a leash when the leash is attached to a collar worn by an animal generally includes an elastic adapter. The system may also include at least three eyelets operatively associated with the elastic adapter member. Each of the at least three eyelets may include an opening therethrough configured to frictionally receive at least a portion of the leash therein. A first member is adjacent a proximal end portion of the elastic adapter for anchoring, attaching, or engaging to the leash. A second member is adjacent a distal end portion of the elastic adapter for anchoring, attaching, or engaging to the leash.

Other aspects of the present disclosure relate to methods. In one exemplary embodiment, a method of managing slack in a leash generally includes threading a leash through at least three eyelets of an elastic adapter to thereby form a friction fit between the leash and the at least three eyelets of the elastic adapter. The method also includes anchoring, attaching, or engaging proximal and distal end portions of the elastic adapter to the leash.

Further areas of applicability will become apparent from the description provided herein. The description and specific examples in this summary and drawings are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure in any way.

FIG. 1 is a perspective view of an exemplary embodiment of an adapter attached to a leash, and illustrating the adapter in a retracted configuration in which the adapter is helping to manage the slack in the leash;

FIG. 2 is another perspective view of the adapter and leash shown in FIG. 1, but illustrating the adapter in an extended or stretched configuration;

FIG. 3 is a perspective view of another exemplary embodiment of an adapter;

FIG. 4 is a perspective view of another exemplary embodiment of an adapter;

FIG. 5 is a perspective view of another exemplary embodiment of an adapter;

FIG. 6 is a perspective view of an exemplary eyelet that may be used with an adapter according to exemplary embodiments;

FIG. 7 is a top plan view of the eyelet shown in FIG. 6;

FIG. 8 is a top plan view of a portion of an adapter and an eyelet thereof according to another exemplary embodiment;

FIG. 9 is a top plan view of a portion of another exemplary embodiment of an adapter and an eyelet thereof;

FIG. 10 is a perspective view of another exemplary embodiment of an adapter attached to a leash, and illustrating the adapter in an extended or stretched position;

FIG. 11 is another perspective view of the adapter and leash shown in FIG. 10, but illustrating the adapter in a retracted configuration in which the adapter is helping to manage the slack in the leash;

FIG. 12 is a perspective view of another exemplary embodiment of an adapter attached to a leash through eyelets and knots, and illustrating the adapter in an extended or stretched position; and

FIG. 13 is a perspective view of another exemplary embodiment of an adapter with eyelets and enlarged members or portions at an end portion of the adapter.

Corresponding reference numerals indicate corresponding parts throughout the several views of the drawings.

### DETAILED DESCRIPTION

In the following description, numerous specific details are set forth such as examples of specific components, devices, and methods, in order to provide a thorough understanding of embodiments of the present disclosure. It will be apparent to a person of ordinary skill in the art that these specific details need not be employed, and should not be construed to limit the scope of the disclosure. In the development of any actual implementation, numerous implementation-specific decisions must be made to achieve the developer's specific goals, such as compliance with system-related and business-related constraints. Such a development effort might be complex and time consuming, but is nevertheless a routine undertaking of design, fabrication and manufacture for those of ordinary skill.

As recognized by the inventor hereof, a conventional leash has slack when the pet stops walking or is walking in the “heel” position, or when a leash is mounted to an inanimate stationary object, such as a fence post, gate, etc. The slack in a leash may eventually end up tangled on objects such as bushes, in between the pet's legs, the owner's or pet walker's legs, or both, causing potential harm to both the walker/owner and pet and delays in exercising the pet, or the slack may end up tangling the leash. Leashes with incorporated hardware or built-in hardware, besides having the potential problem with slack, tend to have one or more of the following additional disadvantages: the incorporated hardware or built-in hardware damages the leash, is permanently affixed to the leash, adds weight, metal, or other material that can affect the pet and walker/owner, adds additional tension to the pet, and is geared to correct behavior.

According to various aspects of the present disclosure, there are provided various exemplary embodiments of adapters, devices, and systems to help manage slack in leashes. In an exemplary embodiment, a system, device, or adapter generally includes an elastic adapter which is operable for retracting the leash (e.g., by forming one or more loops in the leash slack, etc.). The system, device, or adapter may include one or more eyelets configured to form a friction fit or interference fit with the portions of the leash frictionally received within the openings of the eyelets. In some embodiments, a leash may be threaded through one or more eyelets to create the friction fit between the adapter and the leash. In addition, end portions of the adapter may be anchored or releasably attached to corresponding portions of the leash solely by a friction or interference fit formed by the frictional engagement of the leash portions and the corresponding openings of the eyelets. As another example, an end portion of the adapter may be attached to a corresponding portion of the leash solely by a knot (e.g., ram's head knot, etc.), which may be formed in the leash by inserting/threading a loop/handle of the leash at least partially through an eyelet of the adapter and then looping/threading the remaining portion of the leash through that portion of the leash's loop/handle sticking out the other side of the eyelet.

In another exemplary embodiment, an adapter is comprised of elastomeric material that is configured to manage the slack in the leash. In various embodiments, an adapter may be integrally molded from or comprise polyurethane, thermoplastic rubber or thermoplastic resin, such as hydrogenated styrened isoprene/butadiene block copolymer, a block copolymer, etc. Accordingly, the adapter may thus be monolithically formed to have a single piece construction.

In various embodiments, the end portions of an adapter is anchored, attached, or engaged to portions of a leash, to thereby inhibit or prevent movement of the adapter's end portions relative to the leash portions to which the adapter's end portions are anchored, attached or engaged. An adapter may have one or more members (e.g., enlarged portion or member, ball, cylindrical member, oval member, knot, etc.), such as adjacent or along the respective proximal and distal end portions of the elastic adapter, to facilitate the anchoring, attachment, or engagement of the end portions of the adapter to the leash. The members or enlarged portions may be integral to an adapter, or they may be separately attached to the adapter, such as by adhesives, etc.

In exemplary embodiments, an adapter generally includes an opening, hole, and/or an eyelet or loop with an opening or hole therethrough. In further embodiments, an adapter may include first and second members for anchoring, attaching, or engaging the leash where the first and second members comprise eyelets that are integral to the adapter. In alternative various embodiments, there may be provided a plurality of eyelets in the adapter. The holes through the eyelets may, for example, have diameters that are equal to or less than the dimensional size (e.g., width, diameter, thickness, etc.) of the leash portion threaded into and received therein, in order to create a friction or interference fit between eyelets and a leash. By way of example, an eyelet at one or both end portions of the adapter may be sized so as to create a relatively strong friction fit with the leash, to allow the corresponding end portion of the adapter to be anchored to the corresponding portion of the leash solely by that relative strong friction fit. In another exemplary embodiment, the diameter of the eyelets might vary amongst eyelets in the adapter, such that one eyelet has a larger diameter and one eyelet has a smaller diameter. Alternative embodiments may include adapters with eyelets having all the same diameter.

In further embodiments, one or more eyelets of an adapter may include outer covers. In various embodiments, outer covers may have a variety of diameters depending on the size of eyelet it is covering and the degree of aesthetic additions. Further, in another embodiment, outer covers comprise elastomeric material, similar or identical to the elastic material forming the adapter and eyelets in some embodiments. In yet further embodiments, the elastomeric cover may be integrally molded from or comprise thermoplastic rubber or thermoplastic resin, such as hydrogenated styrened isoprene/butadiene block copolymer, a block copolymer, etc. Alternative materials may also be used for eyelet covers, such as non-elastic materials, fabrics, etc.

In further exemplary embodiments, an adapter may include at least a portion that is aesthetically colored and visually perceptible to an observer, whereby the cosmetic appearance of an adapter may be enhanced. In various embodiments, one or more portions of an adapter (or the entire adapter in some embodiments) may be illuminated, configured to reflect light (e.g., a reflective strip or stripe, imbedded reflective materials, etc.) and/or be aesthetically colored (e.g., neon yellow, etc.) to, among other things, ease application and detachment of the adapter in the dark or at night and create better visibility of the pet or walker/owner in the dark or at night. In further embodiments, the adapter may include at least one or more of a red portion, an orange portion, a yellow portion, a green portion, a cyan portion, a blue portion, an indigo portion, a violet portion, and a portion having a non-metallic color. In some embodiments, an adapter may include one or more indicia, and the indicia may be illuminated or reflective in some embodiments.

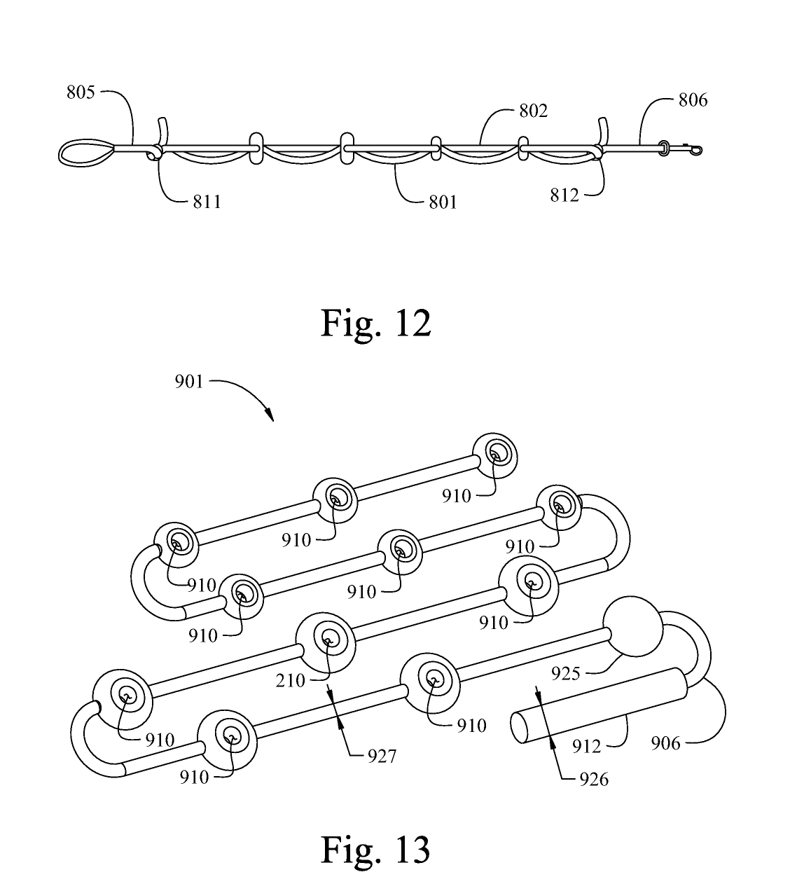

Other aspects relate to methods of using an adapter with a leash. In one exemplary embodiment, a method generally includes threading a leash through at least one eyelet created in an elastic adapter, to form a friction or interference fit between the leash and the at least one eyelet of the adapter. The method may also include anchoring, attaching, or engaging end portions of the elastic adapter to the leash. Depending on the particular embodiment and manner in which the end portions of the adapter are anchored, attached, or engaged to the leash, the end portions of the adapter may be inhibited or even prevented from moving relative to the corresponding portions of the leash to which the adapter's end portions are anchored, attached, or engaged. By way of example, one or both of the end portions of the adapter may be anchored to the leash by tying one or more knots in the leash, where the one or more knots engage a corresponding portion of the adapter, such as an eyelet, a member, enlarged portion, etc. In some embodiments, an adapter is engaged to a leash by engaging at least one knot in the leash with at least one eyelet of the adapter. As another example, a method may include tying one or more knots in the leash (and/or tying one or more knots in the adapter in some embodiments) to anchor, attach, or engage the adapter to the leash. For example, one or more knots may be tied in the leash generally about corresponding end portions of an adapter (e.g., FIG. 12), to thereby anchor, attach, and engage the end portions of the adapter to the leash. In various embodiments, a method may include engaging one or more knots in the leash with either or both of the distal and proximal eyelets of the adapter and/or engaging one or more knots in the leash with one or more stops, members, or enlarged portions of the adapter, where the adapter's one or more stops, members, or enlarged portions inhibit the adapter portion about which leash knot was tied from being pulled out of the knot. The stops, members, or enlarged portions of the adapter may be provided in a variety of forms, such as one or more solid cylindrical, spherical, ovular, and/or ball-like members at one or more end portions of the adapter, one or more protuberances attached to or integral to the adapter, one or more enlarged portions formed by tying a knot in the adapter, etc.

In some method embodiments, the adapter may be comprised of elastomeric material that is configured to manage slack in a leash. The adapter may be integrally molded from or comprise polyurethane, thermoplastic rubber or thermoplastic resin, such as hydrogenated styrened isoprene/butadiene block copolymer, a block copolymer, etc.

In some method embodiments, an adapter may include at least a portion that is aesthetically colored and visually perceptible to an observer, whereby the cosmetic appearance of an adapter may be enhanced. In various embodiments, a substantial portion of an adapter is illuminated and aesthetically colored to, among other things, ease application and detachment of an adapter in the dark or at night or create a better visibility of the pet for others or the walkers/owners in the dark or at night. In further embodiments, an adapter includes at least one or more of a red portion, an orange portion, a yellow portion, a green portion, a cyan portion, a blue portion, an indigo portion, a violet portion, and a portion having a non-metallic color.

In various method embodiments, an adapter may include eyelets having holes with diameters that are equal to or less than the corresponding dimensional size of the leash portion to be threaded into and received in the holes, in order to create a friction fit between the eyelets and leash. In another exemplary embodiment, the diameter of the eyelets and/or holes therethrough might vary amongst each other, such that one eyelet has a larger diameter and one eyelet has a smaller diameter. Alternative embodiments may include an adapter with eyelets having all the same diameter. By way of example, an eyelet at one or both end portions of the adapter may be sized so as to create a relatively strong friction fit with the leash, to allow the corresponding end portion of the adapter to be anchored to the corresponding portion of the leash solely by that relative strong friction fit.

In some method embodiments, an adapter's eyelets may be provided with outer covers. Outer covers in various embodiments may have a variety of diameters depending on the size of the eyelet it is covering and the degree of aesthetic additions. Further, in another embodiment, outer covers are made of elastomeric material, similar to the adapter and eyelets. In yet further embodiments, the elastomeric cover may be integrally molded from or comprise thermoplastic rubber or thermoplastic resin, such as hydrogenated styrened isoprene/butadiene block copolymer, a block copolymer, etc. Alternative materials may also be used for eyelet covers, such as non-elastic materials, fabrics, etc.

In various embodiments, a method of managing slack in the leash allows for one or more of the following features: attachment and detachment of eyelets or adapters to leashes without using any tools, attachment and detachment of eyelets or adapters to leashes without any mechanical fasteners, and attachment and detachment of eyelets or adapters to leashes without compromising the leash's integrity, or creating or putting holes, indentations, or marks in the leash.

Various embodiments may provide one or more benefits and advantages. For example, various embodiments may provide an adapter that inhibits an existing leash's slack from being caught under the legs of an owner/walker or pet, thus, limiting the chance of injury to the pet or to the person holding the leash and walking the pet. In various embodiments, the adapter may inhibit slack in the leash from getting tangled or dragging on the ground. Various embodiments allow for the conversion of any standard leash to be retrofit with a removable adapter, for example, by way of a friction fit between the leash and the removable adapter, thereby allowing the consumer to use a conventional leash with the removable adapter. Various embodiments provide an adapter that does not require any tools or hardware for attachment or detachment of the adapter to/from the leash, and thus, the attachment/detachment and use of the adapter with the leash does not damage or compromise the integrity of the leash. Plus, an adapter according to embodiments disclosed herein may also be relatively easily and quickly assembled and disassembled. Adapters disclosed herein may also be less expensive to manufacture and package for sale, and avoids assembly, instructions and missing parts issues. Moreover, various embodiments provide less than meaningful tension on the pet and thus, the adapter is less intrusive on the pet, person holding the leash, or inanimate stationary object to which the leash is attached, and diminishes the amount of slack in the leash, and does not add additional appreciable weight or force to affect the well being of the pet, person holding the leash, or inanimate stationary object to which the leash is attached, or necessarily act as a training device.

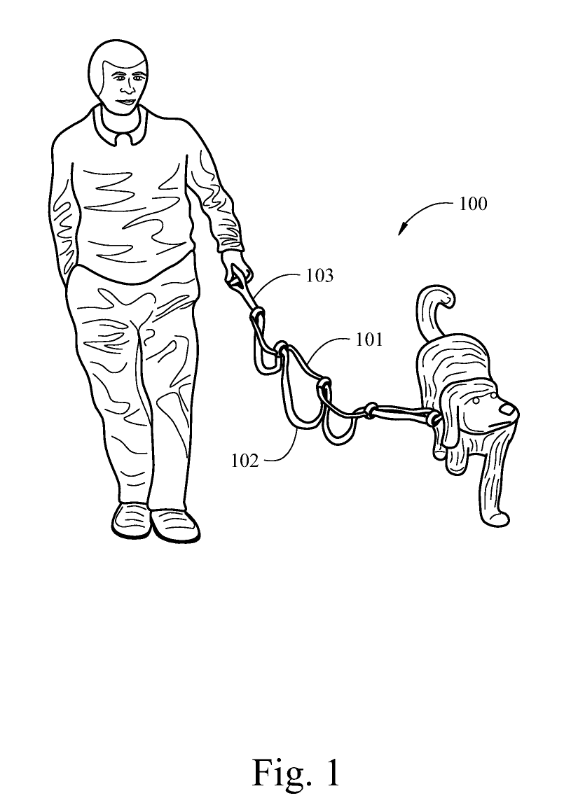

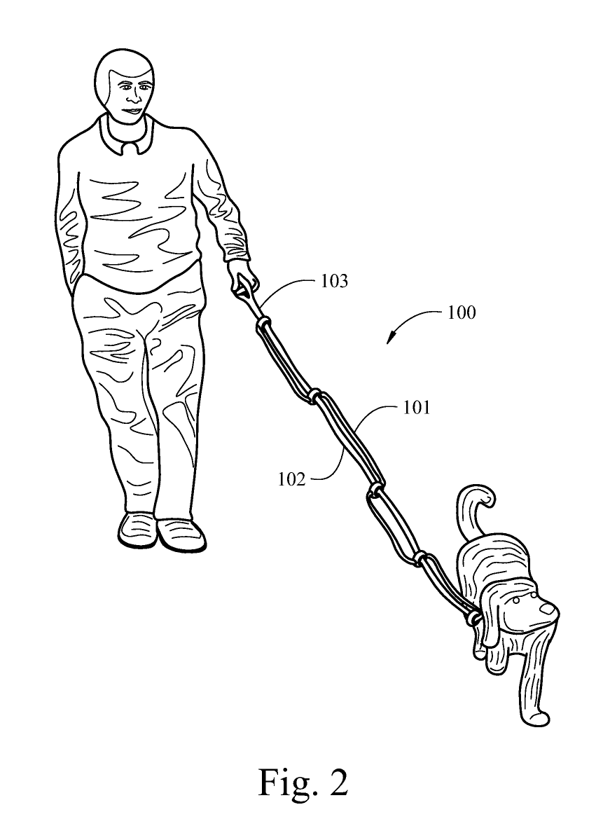

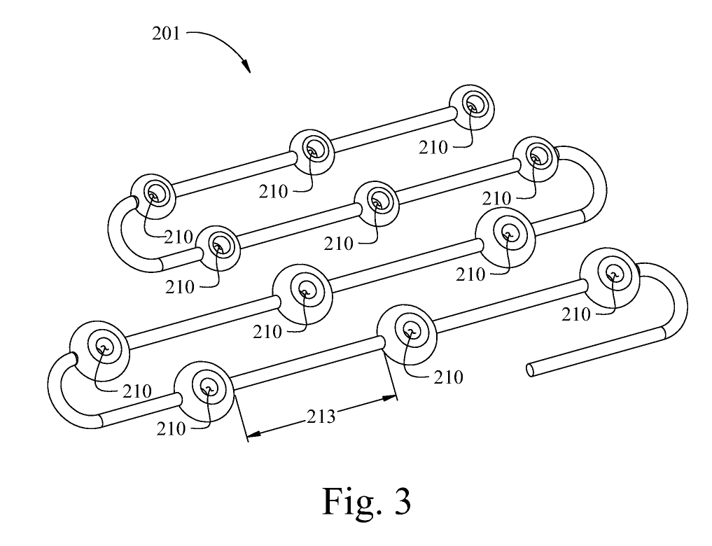

Referring now to FIGS. 1 and 2, there is shown an exemplary embodiment of an adapter 101 for use with a leash 102, where the adapter 101 embodies one or more aspects of the present disclosure. As shown in FIGS. 1 and 2, there is a leash 102, an elastic adapter 101, and at least one eyelet (e.g., see eyelets 210 in FIG. 3, etc.).

A leash may be comprised of various materials, including rope, cable, leather, elastic, braided material, etc. Moreover, in various embodiments, a leash is comprised of various lengths. In exemplary embodiment, a leash may be 10 feet (254 millimeters) in length. In another embodiment, a leash is as small as 3 feet (76.2 millimeters) in length. The leash may be more than 3 feet. (76.2 millimeters) and less than 10 feet. (254 millimeters) in length, such that the leash length is suitable for use with an adapter disclosed herein to effectively manage the slack in the leash. Alternatively, adapters disclosed herein may be used with leashes less than 3 feet. (76.2 millimeters) in length or with leashes greater than 10 feet. (254 millimeters) in length.

The adapter system, illustrated in FIGS. 1 and 2, is held by a human. As is shown in FIGS. 1 and 2, the leash 102 may be attached to a dog's collar. Alternatively, a leash may be attached to other animals or pets, such as a cat, bunny, horse, guinea pig, pig, or other four legged animal. As another example, a leash may also be attached to a toddler. As a further example, the leash may be tied to a stationary object (e.g., fence post, etc.) rather than being held by a human.

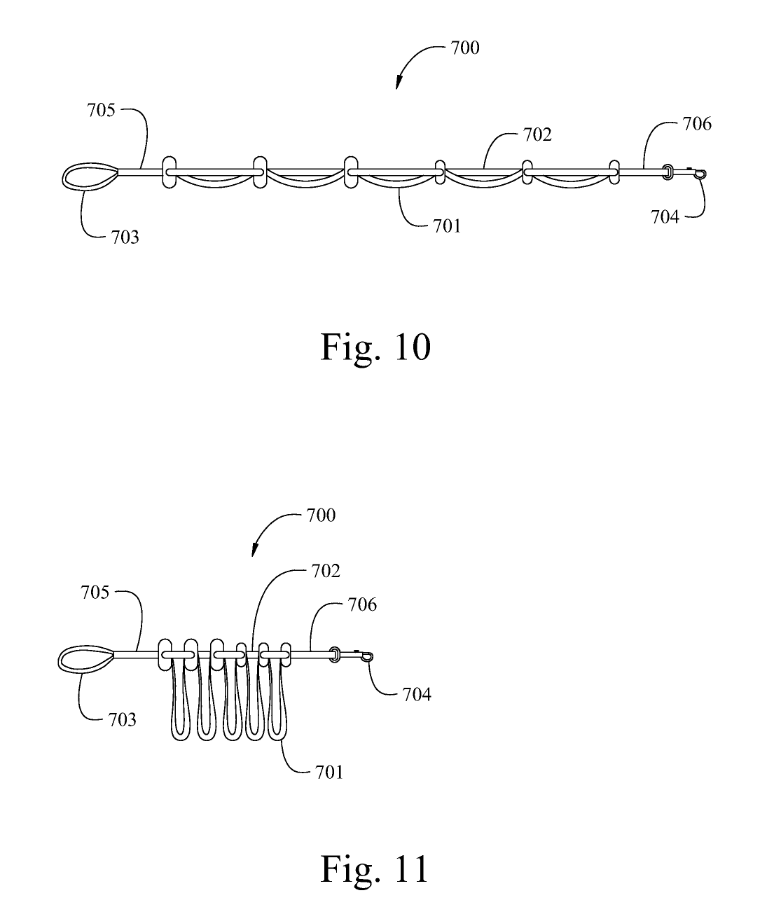

The attachment piece on a leash, in one exemplary embodiment, is a clasp, hook, etc. located at the proximal end portion of the leash adjacent the dog. As illustrated in FIGS. 1 and 2, the proximal end portion of the leash may include a clip (e.g., clip 704 shown in FIGS. 10 and 11, etc.) or any conventional means for attaching the leash to the collar of a pet. In some embodiments, the proximal end portion of the adapter may be anchored, attached, or engaged directly to the clip, clasp, hook, etc. of the leash, such as by a friction or interference fit between the adapter and opening or other portion of the leash's clip, clasp, hook, etc. For example, a portion of the adapter may be forcibly inserted, jammed, etc. into an opening of the clip, clasp, hook, etc. of the leash.

As is further shown in FIGS. 1 and 2, the distal end portion of a leash in one exemplary embodiment, includes a handle 103. Leash handles may be comprised of a loop to be held by the human in his or her hand or held by any other means necessary to restrain or exercise the pet, including a stroller, belt loop, or inanimate and stationary object. Alternative embodiments can include a wide range of other suitable means for handles and for attachments to a pet or pet's collar, such as adhesives, snaps, buttons, Velcro® hook and loop closures, magnets, etc.

FIG. 3 illustrates another exemplary embodiment of an adapter 201 embodying one or more aspects of the present invention. In various embodiments, adapters are comprised of elastic, resiliently flexible, stretchy, and/or low durometer material so that the adapter may extend and retract to track the movement of the pet and manage the slack of a leash. For example, in another exemplary embodiment, the stretch ratio of adapters is between 6:1 and 8:1. Alternative materials with a different, higher, or less stretch ratio may also be used for an adapter. In other embodiments, adapters may be integrally molded from or comprise polyurethane, thermoplastic rubber or thermoplastic resin. In other various embodiments, adapters are made of elastomeric material, and more particularly integrally molded from or comprise thermoplastic rubber or thermoplastic resin, such as hydrogenated styrened isoprene/butadiene block copolymer, a block copolymer, etc. Alternative materials may also be used for adapters.

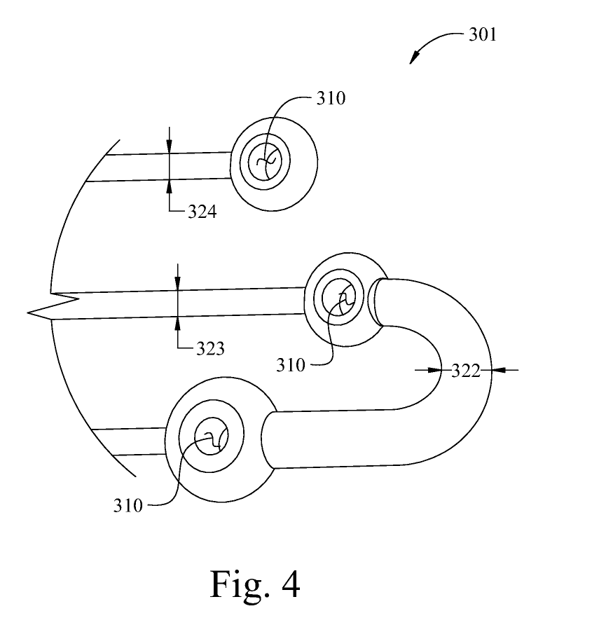

In various embodiments, the dimensions (e.g., diameter, etc.) of an adapter may be uniform along the length of the adapter, or the dimensions vary depending on the particular application. FIG. 4 illustrates an exemplary embodiment of a portion of adapter 301 embodying one or more aspects of the present disclosure. As shown in FIG. 4, this particular portion of the adapter 301 includes three eyelets 310. In addition, this particular portion of the adapter 301 includes different or varying diameters 324 (e.g., between 0.15 inches (3.81 millimeters) and 0.25 inches (6.35 millimeters), etc.). In this example, the diameter 323 of the adapter 301 is less than the diameter 322 of the adapter 301. By way of example, the diameter 323 may be about 0.15 inches (3.81 millimeters) and the diameter 322 may be about 0.25 inches (6.35 millimeters). Alternative configurations (e.g., sizes, shapes, materials, etc.) may be used. And, all dimensions, shapes, and materials disclosed herein are mere examples and can be varied. For example, embodiments may include adapters having non-circular cross sectional profile. Or, for example, in the embodiment illustrated in FIG. 13, the proximal end portion 906 of the adapter 901 has a portion 912 with a larger diameter 926 than the diameter 927 of the remaining elastomeric material of the adapter 901. Alternatively, an adapter may be thicker or thinner and/or with a smaller or larger diameter (or other dimensions for adapters with non-circular cross-sectional) depending on the dimensions of the leash used with a particular adapter, the weight of the pet, and the desired amount of slack in a leash to manage.

In various embodiments, at least a portion of an adapter is aesthetically colored and visually perceptible to an observer, whereby the cosmetic appearance of a system may be enhanced. In various embodiments, a substantial portion of an adapter is illuminated, reflective (e.g., reflective strip or stripe, etc.) and/or aesthetically colored to ease application and detachment from a leash in the dark and at night and for visibility by others, the owner/walker, or pet in the dark or at night for safety purposes. In various embodiments, adapters include at least one or more of a red portion, an orange portion, a yellow portion, a green portion, a cyan portion, a blue portion, an indigo portion, a violet portion, and a portion having a non-metallic color.

In other exemplary embodiments, adapters may vary in length depending on the dimensions of a leash, the weight of the pet, and/or the pet walker's personal preference for the amount of slack to manage. For example, as illustrated in FIGS. 1 and 2, an adapter 101 may be substantially the length of a leash 102 to manage slack in the leash 102. In other embodiments, however, adapters might be sized so as to substantially shorter in length to manage a shorter portion of a leash or to manage a shorter leash. In exemplary embodiments, adapters are 1 inch (25.4 millimeters) in length, and in other embodiments, adapters are 9 inches (228.6 millimeters) in length. The dimensions set forth in this paragraph, as are all dimensions disclosed herein, are mere examples and can be varied.

FIG. 3 illustrates another embodiment of an adapter 201, which comprises eyelets 210. In various embodiments, eyelets (and/or one or more knots or loops that form openings, etc.) are comprised of elastic, resiliently flexible, stretchy, and/or low durometer material. In one exemplary embodiment, the stretch ratio of an eyelet material is between 6:1 and 8:1. Alternative materials with a different, higher, or less stretch ratio may also be used for eyelets. In other various embodiments, eyelets may be integrally molded from or comprise polyurethane, thermoplastic rubber, or thermoplastic resin. In other various embodiments, eyelets are made of elastomeric material, including thermoplastic rubber or thermoplastic resin, such as hydrogenated styrened isoprene/butadiene block copolymer, a block copolymer, etc. Alternative materials may also be used for eyelets.

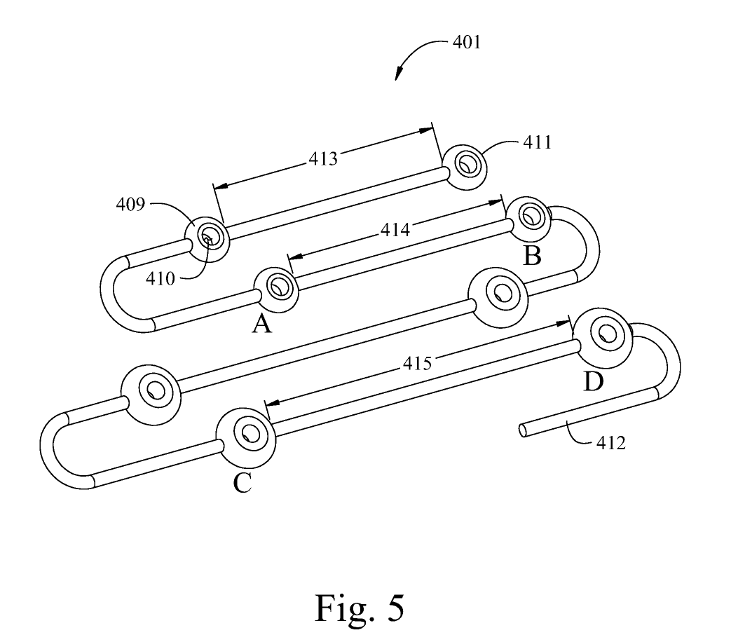

The illustrated adapter 201 includes twelve eyelets 210 to manage slack in a leash. However, in other exemplary embodiments, adapters may include more than or less than twelve eyelets to manage slack in a leash. For example, FIG. 5 illustrates an exemplary embodiment of an adapter 401 including eight eyelets 410 to manage slack in a leash. In other various embodiments, the number of eyelets may be zero, one, two, three, four, five, six, seven, eight, nine, ten, eleven, or more than twelve. In an alternative embodiment shown in FIG. 13, the adapter 901 includes eleven eyelets 910, a member 925 (e.g., a ball or spherically-shaped member, etc.) and member 912. The members 925 and 912 may be used for attachment of the adapter 901 to a leash. For example, a knot may be tied in the leash generally about the portion 906 of the adapter 901 with the members 912 and 925 on the opposite sides of the knot in the leash. In this exemplary manner, the members 912 and 925 would essentially operate as stops to inhibit relative movement of the adapter portion 906 and the knot in the leash, to thereby inhibit the adapter portion 906 from being pulled out of the knot in the leash. The members 912 and 925 may be provided in a variety of forms, such as one or more solid cylindrical, spherical, ovular, and/or ball-like members at one or more end portions of the adapter, one or more protuberances attached to or integral to the adapter, one or more enlarged portions formed by tying a knot in the adapter, etc. Or, for example, other embodiments may include one or more knots tied in the adapter generally about a portion of the leash with one or more stops, members enlarged portions, etc. on the opposite sides of the knot in the adapter to inhibit the knot from coming untied. As yet another example, knots may be tied in both the leash and the adapter or the leash and adapter may be tied to each other, e.g., with a surgeon's knot, etc. The number of eyelets that an adapter has might vary for ease of attachment and detachment, to increase or decrease the friction fit on a leash, depending on the size of the pet, because of the dimensions of a leash, and based on the amount of desired slack to manage. For example, an adapter may include seven eyelets when the adapter is intended to be used with a six-foot long leash. As another example, an adapter may include eleven eyelets when the adapter is intended to be used with a ten-foot long leash.

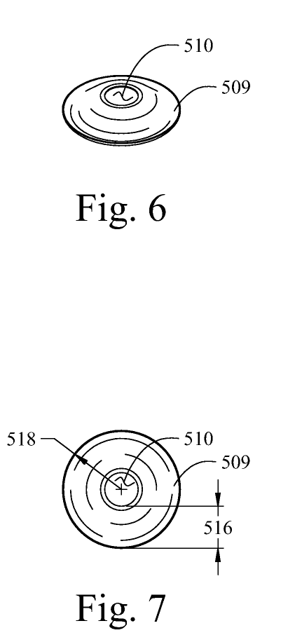

In a further exemplary embodiment, the eyelets 510 may include a cover 509, as illustrated in FIGS. 6 and 7. Various embodiments may include covers 509 that are elastic, resiliently flexible, stretchy, and/or low durometer so that the covers may snugly fit over eyelets, which are friction fitted with the leash. Alternative embodiments may include one or more eyelet covers that are made of non-stretch fabric and/or a lighter or less heavy material.

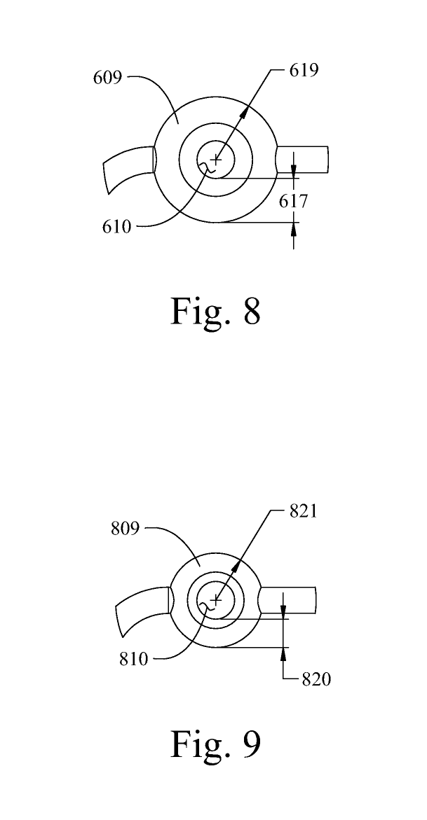

In further embodiments, the diameter of the covers may vary. FIG. 8 illustrates an exemplary embodiment of an eyelet 610 and eyelet cover 609. In the particular embodiment depicted in FIG. 8, the cover may be formed from material such that the distance 617 is 0.21 inches (5.33 millimeters). Alternative dimensions and materials may be used, for example, covers may be made thicker or thinner material and/or with smaller or larger diameters. For example, FIG. 9 illustrates an exemplary embodiment of a cover 809 formed of material such that the distance 820 is 0.135 inches (3.429 millimeters).

In various embodiments, the size of eyelets and eyelet covers may differ in one adapter, or an adapter may have eyelets and eyelet covers that are uniform in size throughout. In one exemplary embodiment, eyelets are sized so that the diameter of the holes therethrough are equal to or less than the dimensional size of the leash portions positioned within the eyelet holes. FIG. 8 illustrates an exemplary embodiment of an eyelet 610 and eyelet cover 609. In the particular embodiment illustrated in FIG. 8, the radius 619 may be 0.30 inches (7.62 millimeters). Alternative dimensions may be used, as eyelets and covers may be made thicker or thinner and/or with smaller or larger radius depending on the size of the leash for which the adapter is being used, pet in which adapters are used with, and desired amount of slack the owner or pet walker intends on managing. For example, FIG. 9 illustrates another exemplary embodiment of a cover 809 and eyelet 810. In the particular embodiment illustrated in FIG. 9, the radius 821 may be 0.225 inches (5.715 millimeters).

In further exemplary embodiments, the distance between eyelet covers along the length of an adapter can vary or the distance between eyelet covers can be uniform along the length of an adapter. For example, FIG. 5 illustrates an exemplary embodiment of an adapter 401 in which the length 413 is not the same or uniform between each adjacent pair of eyelets 410. In the particular embodiment illustrated in FIG. 5, the alphabetic letters A and B shown in FIG. 5 are separated by a length 414 of elastomeric material that may be 1.8 inches (45.72 millimeters), and alphabetic letters C and D may be separated by a length 415 of elastomeric material of 2.3 inches (58.42 millimeters). Alternative dimensions may be used as eyelet covers may be made closer together with less length of elastomeric material separating eyelet covers, or they may be farther apart with a greater length of elastomeric material separating eyelet covers depending on the leash size, pet size, and/or amount of slack the pet owner or walker desires to manage. Moreover, using an adapter 401 as illustrated in FIG. 5 in which the distance 413 between eyelet covers 409 varies or is not uniform, may allow a portion of the adapter 401 to be in a state in between a relaxed state and an extended state during use.

In other exemplary embodiments, at least a portion of eyelet covers are aesthetically colored and visually perceptible to an observer, whereby the cosmetic appearance of the system may be enhanced. In various embodiments, covers may comprise suitable ornamentation or decoration such as rhinestones, different colors, or the like. In various embodiments, a substantial amount of eyelet covers are illuminated and aesthetically colored to ease application and detachment of adapters at night or in the dark and for better visibility of the pet and pet walker/owner at night or in the dark for safety purposes. In various embodiments, covers include at least one or more of a red portion, an orange portion, a yellow portion, a green portion, a cyan portion, a blue portion, an indigo portion, a violet portion, and a portion having a non-metallic color.

With reference to FIG. 5, an adapter 401 may also include a first member 411. The first member 411 may be a first eyelet 411 to be positioned adjacent an end portion of a leash. In other embodiments, a first member may be configured to secure to a leash through threading, knotting, or some other means so as to secure positively and not just with a friction hold. For example, FIG. 12 illustrates another exemplary embodiment of an adapter 801 in which the first member 811 is a portion of the adapter 801 about which a knot in the leash 802 has been tied. In this example, the knot may be tied in the leash 802 generally about an end portion of the adapter 801. Alternative embodiments may include first members comprised of other means depending on the adapter size, leash dimensions, pet size, and/or the pet owner's or walker's preferred amount of slack to be managed. In other alternative embodiments, first members may be positioned on the end portion of adapters and configured to secure on the end portion of a leash. Alternatively, first members may be positioned on the end portion of adapters and configured to secure in the middle portion of a leash. In other various embodiments, first members may be integrally molded from or comprise polyurethane, thermoplastic rubber or thermoplastic resin. In other various embodiments, first members are made of elastomeric material, thermoplastic rubber or thermoplastic resin, such as hydrogenated styrened isoprene/butadiene block copolymer, a block copolymer, etc. Alternative materials may also be used for first members.

With continued reference to FIG. 5, the adapter 401 may include a second member 412. In various embodiments, second members can be eyelets or configured to secure on the leash through threading, knotting, or some other means. As shown in FIG. 5, the second member 412 is a member that may be attached to a leash through a knot. For example, the second member 412 itself may be tied into a knot generally about a portion of a leash. Or, for example, a knot may be tied in a leash generally about the second member 412. As a further example, knots may be tied in both the second member 412 and in the leash. As an additional example, the second member 412 and leash may be tied directly to each other, e.g., with a surgeon's knot.

FIG. 12 illustrates another exemplary embodiment of an adapter 801 in which the second member 812 is attached to the leash 802 by a knot in the leash 802 that is tied generally around the portion 812 of the adapter 801 adjacent the end portion 806 of the leash. FIG. 13 illustrates another exemplary embodiment in which the adapter 901 has an end portion 906 with members 912 and 925. A knot may be tied in the leash generally about the portion of the adapter 901 between members 912 and 925 such that the members 912 and 925 will be on opposite sides of the knot in the leash. Having the members 912 and 925 disposed on opposite sides of the knot allow the members 912 and 925 to operate as stops for inhibiting inhibit slippage or relative movement of the adapter 901 through the knot in the leash. Accordingly, the members 912 and 925 thus inhibit the adapter portion 906 about which the knot in the leash was tied from being pulled out of the knot in the leash. Alternative embodiments may include second members comprised of other means depending on the adapter size, leash dimensions, pet size, and/or the pet owner's or walker's preferred amount of slack to be managed. In other various embodiments, second members may be positioned on the distal end portion of adapters and configured to secure on the distal end portion of a leash. Alternatively, second members may be positioned on the distal end portion of adapters and configured to secure in the middle portion of a leash. In other various embodiments, second members may be integrally molded from or comprise polyurethane, thermoplastic rubber or thermoplastic resin. In other various embodiments, second members are made of elastomeric material, including thermoplastic rubber or thermoplastic resin, such as hydrogenated styrened isoprene/butadiene block copolymer, a block copolymer, etc. Alternative materials may also be used for second members.

Adapters may be attached to leashes in such a way as to allow detachment to occur without compromising the integrity of adapters, eyelets, eyelet covers, and/or leashes. In an exemplary embodiment, leashes are threaded through eyelets such that a friction fit is formed between the leash and eyelets. Adapters or eyelets may also be attached or fitted to a leash in other various manners, including knots or some other means. In alternative embodiments, attachment of an adapter to a leash does not involve making or creating holes in a leash or other integrity compromising marks on a leash. In further alternative exemplary embodiments, adapters are removed or detached from a leash by reverse threading and/or untying, or in some other way removing the means of the adapter from the leash. In various embodiments, the process of attaching adapters and detaching adapters does not involve the use of any hardware or tool. Alternatively, the process of attaching adapters and detaching adapters is accomplished without creating or forming holes in the leashes. Further exemplary embodiments may include attachment of the proximal or distal end portion of adapters, eyelets, or first and second members (e.g., eyelets, enlarged portions, knots, etc.) that does not involve the use of mechanical fasteners and may be attached using, for example, knots.

In various embodiments, eyelets are disposed in various locations so that the adapter is operable for managing slack in a leash by forming one or more loops in a leash to dynamically take up slack in a leash. In an exemplary embodiment, eyelets are positioned on a leash such that a leash may be shortened up to 50% or more when an adapter is in a retracted position. In a further exemplary embodiment, eyelets may be positioned on a leash such that a leash is shortened more than 50% when an adapter is in a retracted position. Alternative placement of eyelets on adapters can be used depending on the desired amount of slack the pet owner or walker wants adapters to maintain, the size of the pet, and the dimensions of a leash, etc.

In alternate embodiments, the placement of the adapter, eyelets, and first and second members relative to the leash vary. For example, as illustrated in FIG. 10, the system 700 includes the distal end portion of the adapter 701 attached to the distal end portion 705 of the leash 702, and the proximal end portion of the adapter 701 attached to the proximal end portion 706 of the leash 702. In another exemplary embodiment, only the distal end portion of the adapter may be anchored, attached, or engaged to the distal end portion of a leash, and the proximal end portion of the adapter may be located other than at the proximal end portion of the leash. In another exemplary embodiment, only the proximal end portion of an adapter may be anchored, attached, or engaged to the proximal end portion of a leash, and the distal end portion of the adapter may be located other than at the distal end portion of the leash.

If the pet is moving in the “heel” position, stops moving, is attached via a leash to an inanimate stationary object, or for any other reason a leash contains slack, adapters attached to a leash may retract, as illustrated in FIG. 11, and gather the slack in the leash 702 and/or shorten the distance between the proximal and distal end portion 705, 706 of the leash 702. In various embodiments, the slack in the leash may create one or more loops in the leash. While the pet is moving in such a manner that the leash 702 does not create slack but is substantially extended, as illustrated in FIG. 10, the adapter 701 may extend substantially the length of the leash 702 between the proximal and distal end portions 705, 706 of the leash 702. Alternatively, the adapter may extend less than the substantial length of the leash. The slack is managed dynamically and continuously with virtually or essentially no additional weight or tension added to the leash, which is unlike spring-retractable spooled leashes and bungee-type leashes. In some embodiments, the weight of the adapter is between about one ounce and two ounces. Other embodiments may include an adapter that is less than one ounce or more than two ounces in weight. In alternative embodiments, adapters add tension in an extended position substantially equal to that of a substantially extended leash without an adapter. Thus, in various embodiments, these adapters create a negligible tension on the pet as compared to a conventional leash. The weight of the adapter and the tension employed by use of the adapter may vary.

Terms such as “upper,” “lower,” “inner,” “outer,” “inwardly,” “outwardly,” “proximal”, “distal”, “adjacent” and the like when used herein refer to positions of the respective elements as they are shown in the accompanying drawings, and the disclosure is not necessarily limited to such positions. Terms such as “first,” “second,” and other numerical terms when used herein do not imply a sequence or order unless clearly indicated by the context.

When introducing elements or features and the exemplary embodiments, the articles “a,” “an,” “the” and “said” are intended to mean that there are one or more of such elements or features. The terms “comprising,” “including,” and “having” are intended to be inclusive and mean that there may be additional elements or features other than those specifically noted. It is further to be understood that the method steps, processes, and operations described herein are not to be construed as necessarily requiring their performance in the particular order discussed or illustrated, unless specifically identified as an order of performance. It is also to be understood that additional or alternative steps may be employed.

The foregoing description of the embodiments of the present invention has been provided for purposes of illustration and description. All dimensions and materials set forth here are mere examples and can be varied depending, for example, on the particular end use of the leash and adapter system. It is not intended to be exhaustive or to limit the invention to the precise forms disclosed. Individual elements or features of a particular embodiment are generally not limited to that particular embodiment, but, where applicable, are interchangeable and can be used in a selected embodiment, even if not specifically shown or described.

What is claimed is:

1. A method of managing slack in a leash, the method comprising:
threading a leash through at least three eyelets of an elastic adapter to thereby form a friction fit between the leash and the at least three eyelets of the elastic adapter;
anchoring a distal end portion of the elastic adapter to the leash; and
anchoring a proximal end portion of the elastic adapter to the leash.

2. The method of claim 1, further comprising detaching the elastic adapter from the leash by detaching the proximal and distal end portions of the elastic adapter from the leash and reverse threading of the leash back through the at least three eyelets of the elastic adapter.

3. The method of claim 1, further comprising detaching the elastic adapter from the leash without using any tools.

4. The method of claim 1, wherein the proximal and distal end portions of the elastic adapter are anchored to the leash without using any mechanical fasteners.

5. The method of claim 1, wherein the proximal and distal end portions of the elastic adapter are anchored to the leash without requiring or using any holes in the leash.

6. The method of claim 1, wherein:
the leash is threaded through the at least three eyelets of the elastic adapter; and
the proximal and distal end portions of the elastic adapter are anchored to the leash without using any tools.

7. The method of claim 1, wherein the threading and anchoring does not require holes in the leash, whereby integrity of the leash is not compromised.

8. The method of claim 1, wherein the elastic adapter is operable for dynamically managing slack in the leash by forming one or more loops in the leash to take up the slack in the leash.

9. The method of claim 1, wherein:
the distal end portion of the elastic adapter is anchored to a distal end portion of the leash, whereby movement of the distal end portion of the elastic adapter relative to the distal end portion of the leash is inhibited; and
the proximal end portion of the elastic adapter is anchored to a proximal end portion of the leash, whereby movement of the proximal end portion of the elastic adapter relative to the proximal end portion of the leash is inhibited.

10. The method of claim 1, wherein anchoring at least one of the proximal and distal end portions of the elastic adapter to the leash includes engaging at least one eyelet of the adapter with at least one knot in the leash.

11. The method of claim 10, further comprising tying the at least one knot in the leash.

12. The method of claim 1, wherein anchoring at least one of the proximal and distal end portions of the elastic adapter to the leash includes engaging at least one knot in the leash with at least one member of the elastic adapter.

13. The method of claim 12, further comprising tying the at least one knot in the leash.

14. The method of claim 1, wherein at least one of the proximal and distal end portions of the elastic adapter is anchored to the leash solely by a friction fit formed by a portion of the least and at least one eyelet of the adapter.

15. The method of claim 1, wherein anchoring at least one of the proximal and distal end portions of the elastic adapter to the leash includes tying at least one knot in the leash.

16. The method of claim 1, wherein anchoring at least one of the proximal and distal end portions of the elastic adapter to the leash includes engaging at least one knot in the leash with at least one enlarged portion of the elastic adapter.

17. The method of claim 1, wherein anchoring at least one of the proximal and distal end portions of the elastic adapter to the leash includes tying at least one knot in the leash generally about a portion of the elastic adapter generally between two enlarged portions of the elastic adapter, such that the two enlarged portions are on opposite sides of the knot.

18. The method of claim 1, wherein:
anchoring the distal end portion of the elastic adapter to the leash includes engaging a first knot in the leash with a distal one of the at least three eyelets of the elastic adapter; and
anchoring the proximal end portion of the elastic adapter to the leash includes engaging a second knot in the leash with a proximal one of the at least three eyelets of the elastic adapter.

19. The method of claim 1, wherein the elastic adapter and the at least three eyelets are integrally molded from thermoplastic rubber or thermoplastic resin, such that the at least three eyelets are integral to the elastic adapter.

20. A system for managing slack in a leash when the leash is attached to a collar worn by an animal, the system comprising:
an elastic adapter;
at least three eyelets operatively associated with the elastic adapter member, each of the at least three eyelets including an opening therethrough configured to frictionally receive at least a portion of the leash therein;
a first member adjacent a proximal end portion of the elastic adapter for releasable attachment to the leash; and
a second member adjacent a distal end portion of the elastic adapter for releasable attachment to the leash.

21. The system of claim 20, wherein the system is operable for dynamically retracting the leash slack by forming one or more loops in the leash.

22. The system of claim 20, wherein at least one of the at least three eyelets has an outer cover.

23. The system of claim 20, wherein:
the elastic adapter has a length when in a relaxed state that is substantially less than the length of the leash disposed between the first member and second member; and
the elastic adapter has a length when substantially extended to be substantially equal in length to the length of the leash disposed between the first member and second member.

24. The system of claim 20, wherein the at least three eyelets includes a predetermined number of eyelets, the predetermined number being three, four, five, six, seven, eight, nine, ten, eleven, or twelve.

25. The system of claim 20, wherein the at least three eyelets are integral to the elastic adapter.

26. The system of claim 20, wherein the elastic adapter and the at least three eyelets are integrally molded from thermoplastic rubber or thermoplastic resin.

27. The system of claim 20, wherein the at least three eyelets are entirely formed from thermoplastic rubber or thermoplastic resin without any additional material being used for reinforcing the openings of the at least three eyelets.

28. The system of claim 20, wherein the elastic adapter, the first and second members, and the at least three eyelets comprise thermoplastic rubber or thermoplastic resin.

29. The system of claim 20, wherein the elastic adapter, the first and second members, and the at least three eyelets comprise hydrogenated styrened isoprene/butadiene block copolymer.

30. The system of claim 20, wherein the first and second members are integral to the elastic adapter.

31. The system of claim 20, wherein the first and second members comprise eyelets that are integrally molded along with the elastic adapter.

32. The system of claim 20, wherein the first and second members comprise eyelets that are integrally molded along with the elastic adapter from thermoplastic rubber or thermoplastic resin.

33. The system of claim 20, wherein the first and second members comprise respective first and second eyelets of the at least three eyelets.

34. The system of claim 20, wherein:
the first member comprises a first eyelet of the at least three eyelets that is configured for engaging a first knot in the leash; and
the second member comprises an enlarged portion of the elastic adapter.

35. The system of claim 20, wherein at least one of the first and second members comprises first and second stops spaced apart along the elastic adapter to allow a knot in the leash to be tied generally about the portion of the elastic adapter separating the first and second stops such that the first and second stops are on generally opposite sides of the knot, whereby the first and second stops inhibit relative movement between the knot and the portion of the elastic adapter about which the knot is tied.

36. A leash including the system of claim 21, wherein the leash is threaded through and frictionally engaged with the openings of the at least three eyelets.

37. The leash of claim 36, wherein at least one of the proximal and distal end portions of the adapter is anchored to a corresponding portion of the leash by at least one at least one knot in the leash, without any mechanical fasteners or holes in the leash.

38. The leash of claim 36, wherein the proximal and distal end portions of the adapter are anchored to corresponding portions of the leash without any mechanical fasteners.

39. A leash including the system of claim 21.

40. A device having a single piece construction, and attachable to a leash without mechanical fasters for managing slack in the leash, the device comprising:
an elastomeric member;
at least one eyelet integral to the elastomeric member, the at least one eyelet including at least one opening configured to frictionally receive at least a portion of the leash therein;
a first member integral to the elastomeric member for releasable attachment to the leash; and
a second member integral to the elastomeric member for releasable for releasable attachment to the leash;
wherein the elastomeric member, the at least one eyelet, and the first and second member comprise thermoplastic rubber or thermoplastic resin material.

41. The device of claim 40, wherein the elastomeric member, the at least one eyelet, and the first and second member comprise hydrogenated styrened isoprene/butadiene block copolymer.

42. The device of claim 40, wherein the elastomeric member has a stretch ratio between approximately 6:1 and 8:1.

43. The device of claim 40, further comprising a cover generally surrounding the opening of the at least one eyelet.

44. The device of claim 40, wherein the first and second members comprise respective first and second eyelets.

45. The device of claim 40, wherein at least one of the first and second members comprises first and second stops spaced apart along the elastomeric member to allow a knot to be tied in the leash generally about the portion of the adapter separating the first and second stops such that the first and second stops are on generally opposite sides of the knot, whereby the first and second stops inhibit relative movement between the knot and the portion of the elastomeric member about which the knot is tied.

46. A leash including the device of claim 40, wherein the leash is threaded through and frictionally engaged with the opening of the at least one eyelet, and wherein a knot attaches the device to the leash without any mechanical fasteners or holes in the leash.

47. A leash including the device of claim 40, wherein the leash is threaded through and frictionally engaged with the opening of the at least one eyelet.

48. The device of claim 40, wherein the device weighs between about one ounce and about two ounces.

49. A leash including the device of claim 40.
